(19) United States
(12) Patent Application Publication
(10) Pub. No.: US 2006/0230433 A1
(43) Pub. Date: Oct. 12, 2006

(54) Client device reservation system and method

(75) Inventor: Wen-Chang Chang, Taipei (TW)

Correspondence Address: EDWARDS & ANGELL, LLP, P.O. BOX 55874, BOSTON, MA, 02205, US

(73) Assignee: Invented Corporation, Taipei (TW)

(21) Appl. No.: 11/094,088

(22) Filed: Mar. 29, 2005

(51) Int. Cl. H04L 9/32

(52) U.S. Cl. 726/3

(57) ABSTRACT

A system and a method of client device reservation are connected to at least one terminal device by a network unit, for allowing a user to login the system, reserve a client device and provide a feedback message. The client device reservation system includes a web server installed with a client device reservation interface, for allowing the user to inquire client devices and usage statuses thereof and to make a reservation of a client device; a client device database for allowing a system administrator to record software/hardware information and the usage statuses of the client devices; and at least one terminal device installed with a browser, for allowing the user to execute the client device reservation interface of the web server via the terminal device, so as to make the reservation of the client device and report feedback problems/conditions incurred during using the client device to the system administrator.

### FIELD OF THE INVENTION

The present invention relates to client device reservation techniques, and more particularly, to a client device reservation system and method for remotely inquire and reserve a client device via network connection and also allowing users to report feedback problems and conditions incurred during using the client device to a system administrator.

### BACKGROUND OF THE INVENTION

Traditionally if a staff wishes to borrow an information device from a company where he/she works, generally the staff should notify an administrator of such as borrower name, borrowing item, borrowing time, estimated returning time and so on in an oral manner or in a writing/recording manner, such that the administrator is able to monitor and realize usage statuses of information devices provided in the company. However, in case many information devices are provided for the company staffs to borrow, for instance many testing machine devices are available for research and development personnel to perform testing on new products, or the company may have more than one office or factory, the information devices that have been borrowed may be distributed in different locations, such that the borrowing/returning management of information devices purely depending on manpower is considered not only wasting human resources but also time- and labor-consuming to inquire and maintain the device borrowing/returning information.

Accordingly, a compute system is conventionally utilized to manage the information devices and cooperates with the network technology to provide an online reservation function for users, such that the users can reserve desired information devices via a public network such as Internet. Thereby, when a user selects an information device to be reserved via such online reservation system, the system firstly checks a usage status of this information device. If the usage status indicates that the information device is available for reservation, the system would reserve this information device and locks it to prevent other users from reserving the same information device. If the usage status indicates that the information device has been reserved, the system would inhibit the user from performing the reservation process on this information device.

However, the current online reservation system can only recognize an online reservation status of an information device, but is not able to realize an actual usage status of the physical information device. As a result, a problem may occur that an information device is indicated being available for reservation by the online reservation system, but the physical information device has been impaired in functionality or is still occupied by a previous user, such that a later user who has reserved this information device via the online reservation system is not able to use the information device.

### SUMMARY OF THE INVENTION

In light of the above drawbacks in the prior art, a primary objective of the present invention is to provide a client device reservation system and method, for allowing a user to remotely make a reservation of a client device via a network unit and a terminal device, and also notifying associated personnel by emails; moreover, the user can report problems incurred during using the client device to a system administrator by emails, to serve as reference for the system administrator for system maintenance, such that a problem that a usage status of the client device displayed by the system is not consistent with an actual usage status of the physical client device can be avoided.

In accordance with the foregoing and other objectives, the present invention proposes a client device reservation system connected to at least one terminal device by a network unit, for allowing a user to login the system via the terminal device, reserve a client device and provide a feedback message. The client device reservation system comprises: a network unit such as Internet or an intranet; a client device database for storing data of device rooms, client devices, client operating systems, client device usage statuses and user feedback, such that a user can obtain information of devices located in the device rooms, hardware/software installed in the devices and usage statuses of the devices to serve as reference for the user to make a reservation of a client device; a user database for storing user data, group data and user group data, such that a system administrator can provide different rights of accessing the user database and operating the system for different users, so as to generate different display pictures according to different users' rights; a web server for installing a client device reservation interface to allow the user to access the client device database via the client device reservation interface, wherein the client device reservation interface comprises a security control module, an information inquiry module, a device reservation/cancellation module, a user feedback module, a category statistical analysis module, a report generation module, a data transmission module and an overdue monitor module, for allowing the user to make an inquiry or reservation of the client device and provide a feedback comment to associated personnel after using the client device; and at least one terminal device installed with a browser, for allowing the user to login the client device reservation interface installed in the web server and access to the client device database.

The present invention also proposes a client device reservation method, by which a web server is mounted on a network unit and a client device reservation interface is installed in the web server, for allowing a user to remotely login a client device reservation system, reserve a client device and provide a feedback message. The client device reservation method comprises the steps of: firstly, building a network unit such as Internet or an intranet, and mounting a web server and at least one terminal device on the network unit; storing user data, group data and user group data in a user database; storing data of device rooms, client devices, client operating systems, client device usage statuses and user feedback in a client device database; installing a client device reservation interface in the web server connected to the network unit, and installing a browser in the terminal device; allowing a user to login the client device reservation interface via the terminal device to inquire a usage status of a client device and online reserve the client device when the usage status thereof indicate that the client device is available for reservation, and notifying associated personnel by emails that the client device has been reserved; and finally if the user has some suggestions for the system or identifies some problems during using the client device, storing the user's suggestions and identified problems in a user feedback data file of the client device database, and notifying a system administrator of the user's feedback by emails to serve as reference for system maintenance.

Therefore, the client device reservation system and method in the present invention are connected to a web server by a browser of a terminal device and a network unit, for allowing a user to remotely login a client device reservation interface to inquire a usage status of a client device and reserve the client device under a condition that the client device is available for reservation. In addition, the user can report feedback suggestions thereof and problems/conditions incurred during using the client device to a system administrator to serve as reference for system maintenance.

### BRIEF DESCRIPTION OF THE DRAWINGS

The present invention can be more fully understood by reading the following detailed description of the preferred embodiments, with reference made to the accompanying drawings, wherein:

FIG. 1 is a block schematic diagram showing basic architecture of a client device reservation system according to the present invention;

FIG. 2 is a flowchart showing basic steps of a client device reservation method according to the present invention;

FIG. 3 is a flowchart showing steps of building a user database by the client device reservation method according to the present invention;

FIG. 4 is a flowchart showing steps of building a client device database by the client device reservation method according to the present invention;

FIG. 5 is a flowchart showing steps of making a reservation of a client device by the client device reservation method according to the present invention;

FIG. 6 is a flowchart showing steps of performing overdue notification by the client device reservation method according to the present invention;

FIG. 7 is a flowchart showing steps of performing feedback notification by the client device reservation method according to the present invention;

FIG. 8 is a flowchart showing steps of canceling the reservation of the client device by the client device reservation method according to the present invention;

FIG. 9 is a diagram showing display pictures of device arrangement of device rooms and usage statuses provided by the client device reservation system according to the present invention;

FIG. 10 is a diagram showing display pictures of statistical analysis reports on a device usage rate provided by the client device reservation system according to the present invention;

FIG. 11 is a diagram showing a display picture of reservation/cancellation notification provided by the client device reservation system according to the present invention; and

FIG. 12 is a diagram showing a display picture of overdue notification provided by the client device reservation system according to the present invention.

### DETAILED DESCRIPTION OF THE PREFFERED EMBODIMENTS

Preferred embodiments of a client device reservation system and method proposed in the present invention are described in detail below, which do not set a limitation on the scope of the present invention.

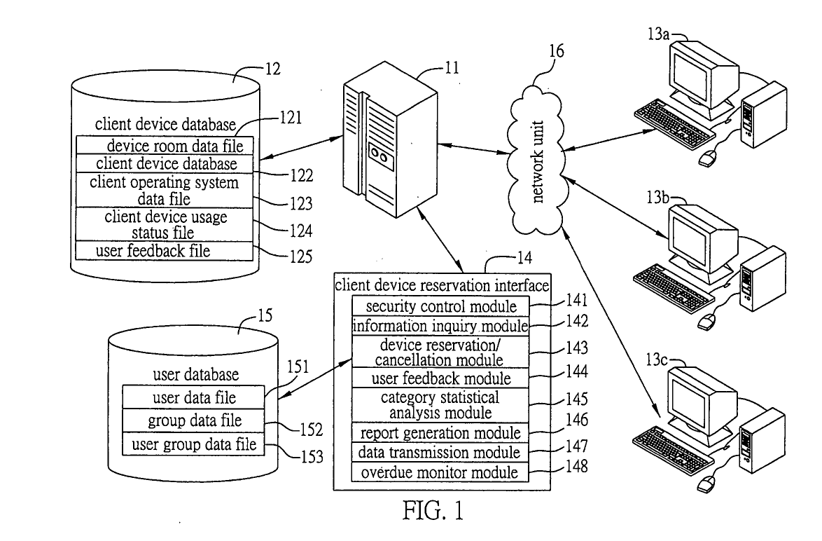

FIG. 1 is a block schematic diagram showing basic architecture of the client device reservation system according to the present invention. As shown in FIG. 1, the client device reservation system comprises a web server 11, a client device database 12, terminal devices 13a, 13b and 13c (the terminal device 13a is exemplified in the following description), a client device reservation interface 14, a user database 15, and a network unit 16.

The web server 11 is installed with the client device reservation interface 14 to perform an inquiry and reservation of client devices and send feedback comments to associated personnel after using the client devices. The terminal device 13a is installed with a browser (e.g. Microsoft Internet Explorer, Netscape Navigator, etc.). A link to the web server 11 can be accomplished via the browser to login the client device reservation interface 14 to perform the inquiry and reservation of the client devices. The network unit 16 can be an intranet or Internet.

The client device database 12 can be installed in a main computer and connected to the web server 11 via a network, or can be directly installed in the web server 11. The client device database 12 comprises a device room data file 121, a client device data file 122, a client operating system data file 123, a client device usage status file 124, and a user feedback data file 125. The device room data file 121 comprises device room serial numbers, device room names, number of device room rows, number of device room columns, number of devices in each row/column in device rooms, and locations of the device rooms, so as to store information related to the locations and arrangement of the device rooms, etc. The client device data file 122 comprises device serial numbers, device names, and device descriptions, so as to store information related to the client devices. The client operating system data file 123 comprises operating system serial numbers and operating system names, so as to store information related to operating systems installed in the client devices. The client device usage status file 124 comprises device room serial numbers, numbers of rows and columns where devices are located, location of the devices within the rows and columns, device serial numbers, operating system serial numbers, reservation statuses, reservation starting time, reservation deadlines, user identification numbers for reservations, project names and testing items, so as to store information related to software/hardware information and reservation statuses of the devices, etc. The user feedback data file 125 comprises device room serial numbers, numbers of rows and columns where devices are located, location of the devices within the rows and columns, device serial numbers, operating system serial numbers, user identification numbers and feedback messages, so as to store feedback messages provided by users on the devices.

The user database 15 can be installed in the main computer and connected to the web server 11 via the network, or can be installed in the web server 11. The user database comprises a user data file 151, a group data file 152, and a user group data file 153. The user data file 151 stores users' personal information such as user identification numbers, user names, account numbers, and passwords. The group data file 152 comprises group identification numbers, group names, access rights and descriptions, so as to store access rights and detailed descriptions of the groups. The user group data file 153 comprises user identification numbers and group identification numbers, so as to store groups to which users belong.

The client device reservation interface 14 such as software is to be installed in and executed by the web server 11 or the main computer. The client device reservation interface 14 comprises a security control module 141, an information inquiry module 142, a device reservation/cancellation module 143, a user feedback module 144, a category statistical analysis module 145, a report generation module 146, a data transmission module 147 and an overdue monitor module 148. The security control module 141 is a security control mechanism used to provide execution of the client device reservation interface 14 and access to the client device reservation database 12. The system administrator needs to add account information of each user to the user data file 151 of the user database 15 to allow the user to login the system. Further, the system administrator also needs to define rights of database access and execution of system functions for each group in the group data file 152. Moreover, the system administrator needs to define a group to which each user belongs in the user group data file 153, such that different users have different rights of database access and execution of system functions according to the groups to which the users belong.

The information inquiry module 142 allows users to inquire each client device in the device rooms, software/hardware information installed in each client device and a usage status thereof. If the device has been reserved, the information inquiry module 142 may display the person who reserves it, the starting time and deadline of reservation, the project name, and the testing items, such that the users can make inquires on client devices satisfying the users' requirements, and further make reservations of the client devices. The information inquiry module 142 further cooperates with the above security control module 141 to provide different inquiry rights for the users according to the rights possessed by the users.

The device reservation/cancellation module 143 allows the users to reserve client devices that have not been reserved in the device rooms. After the users have made the reservations, the device reservation/cancellation module 143 locks the reserved client devices to prevent other users from other users reserving the same client devices. The device reservation/cancellation module 143 further cooperates with the above security control module 141 to provide different reservation rights for the users according to the rights possessed by the users. In addition, the device reservation/cancellation module 143 also allows the users to cancel the reservations of the client devices, and unlocks the locked client devices other users to reserve.

The user feedback module 144 allows the users to report their suggestions on the system and devices, and problems/conditions incurred during using the devices (for example, although the system indicates the usage status of the device as available for reservation, actually the device is still occupied by another user, or software/hardware of the device fails making the device not function properly) to the system administrator.

The category statistical analysis module 145 can provide a statistical analysis on a present or everyday usage rate of each device room, each device, each operating system, to serve as reference for the system administrator for future adjustment of device arrangement. Moreover, the category statistical analysis module 145 can statistically analyze a usage condition for each user.

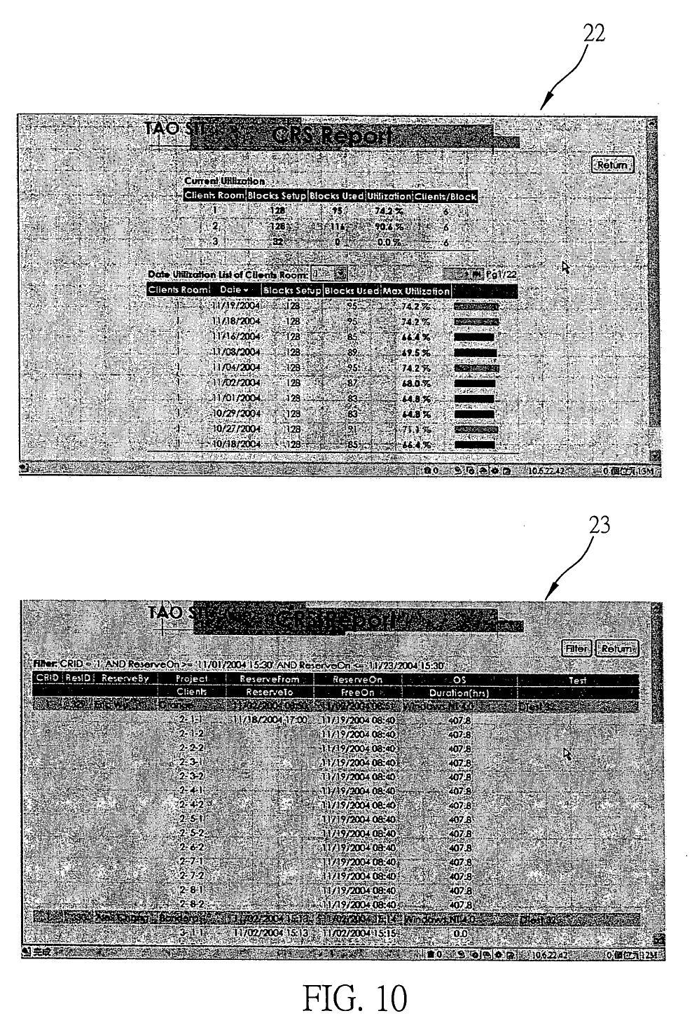

The report generation module 146 generates reports on the results of statistical analysis produced by the category statistical analysis module 145 and the detailed information of devices inquired by the information inquiry module 142. As shown in FIG. 10, the reports comprise a statistical analysis report based on a usage rate of each device in the device rooms generated by the result generated from module 145, a statistical analysis report based on an everyday usage rate of each device room, and a usage inquiry report based on a usage status of each device generated by the information inquiry module 142.

The data transmission module 147 can find out email addresses of associated personnel based on user identification numbers from the user data file 151 of the user database 15 and a staff basic database (not shown), and send messages such as reservation completion notification, overdue notification, user feedback messages, reservation cancellation notification, etc. via the network unit 16 to email systems of a user making the reservation and the system administrator, so as to inform the user and the system administrator that the reservation is complete, the device reservation is overdue, there has been feedback messages from the user, or the device reservation is successfully canceled and the device is unlocked.

The overdue monitor module 148 regularly compares the system present time with a reservation deadline of a device. When the system present time is later than the reservation deadline, the overdue monitor module 148 sends overdue notification via the data transmission module 147 to the email systems of a user who reserves the device and the system administrator, so as to inform the user that the device is going to be unlocked.

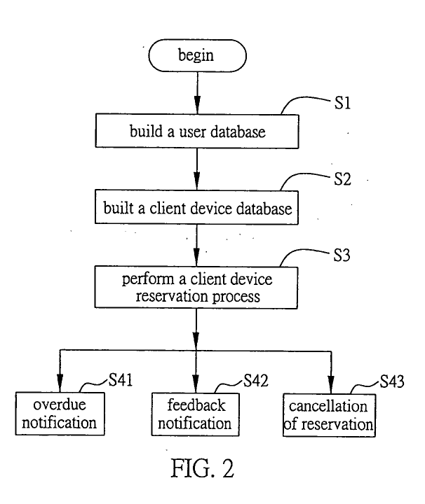

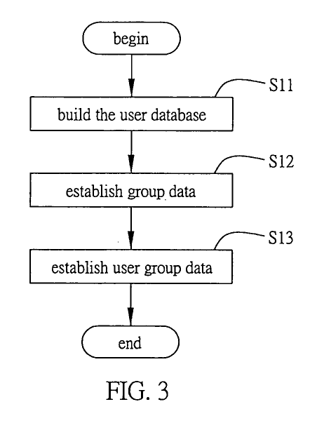

FIG. 2 is a flowchart showing basic steps of the client device reservation method in the use of the client device reservation system according to the present invention. As shown in FIG. 2, firstly in step S1, a user database 15 is established to define rights of accessing a client device database 12 and executing system functions for each user. The detailed steps of building the user database 15 are shown in FIG. 3 and described later. Then, it proceeds to step S2.

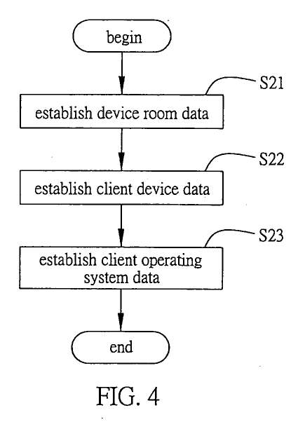

In step S2, the client device database 12 is built to establish detailed information of each device room and software/hardware information in each device in the device room. The detailed steps of building the client device database 12 are shown in FIG. 4 and described later. Then, it proceeds to step S3.

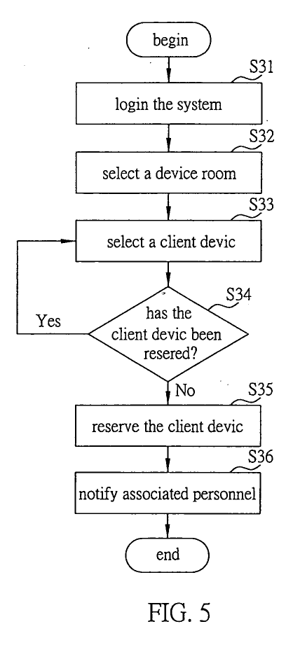

In step S3, the client device reservation system is allowed to perform a process of client device reservations. When a user intends to reserve a particular client device, the user can firstly inquire a usage status of the client device and then perform an online reservation when the usage status of the client device is available for reservation. The detailed steps of reserving the client device are shown in FIG. 5 and described later. Then, it proceeds to step S4.

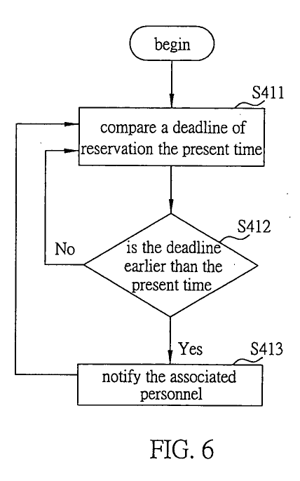

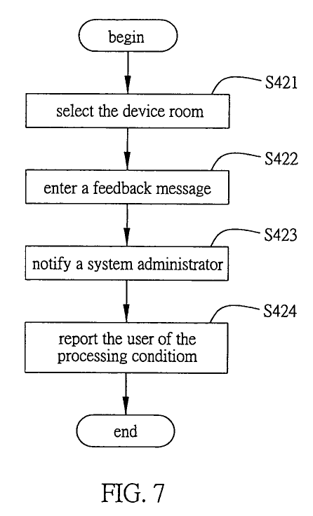

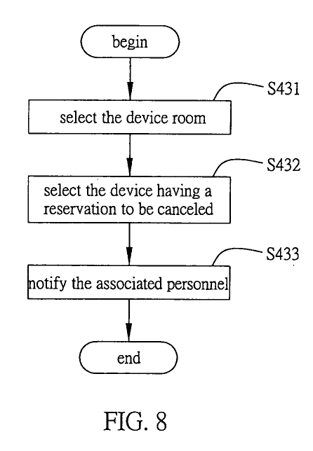

In step S4, the user can select a desired function to be executed from a web picture. If the user selects a function of activating overdue notification, then it proceeds to step S41. The detailed steps of performing overdue notification are shown in FIG. 6 and described later. If the user selects a function of activating feedback notification, then it proceeds to step S42. The detailed steps of performing feedback notification are shown in FIG. 7 and described later. If the user selects a function of activating cancellation of reservation, then it proceeds to step S43. The detailed steps of performing reservation cancellation are shown in FIG. 8 and described later.

FIG. 3 is a flowchart showing steps of building the user database by the client device reservation method according to the present invention. As shown in FIG. 3, firstly in step S11, a user data file 151 is established, and a system administrator needs to enter user identification numbers, user names, account numbers and passwords into the user data file 151, so as to allow the user to login the system via corresponding account number and password stored in the user data file 151. Then, it proceeds to step S12.

In step S12, a group data file 152 is established, and the system administrator needs to enter group identification numbers, group names, access rights and descriptions thereof into the group data file 152, so as to define rights of accessing the client device database 12 and executing system functions for different groups. Then, it proceeds to step S13.

In step S13, a user group data file 153 is established, and the system administrator needs to enter user identification numbers and group identification numbers to which user belong into the user group data file 153, so as to define rights of accessing the client device database 12 and executing system functions for different users according to identification numbers of the groups to which the users belong.

FIG. 4 is a flowchart showing steps of building the client device database 12 by the client device reservation method according to the present invention. As shown in FIG. 4, firstly in step S21, a device room data file 121 is established, and the system administrator needs to enter device room serial numbers, device room names, number of device room rows, number of device room columns, number of devices in each row/column in device rooms and locations of the device rooms into the device room data file 121, so as to allow the user to realize information related to locations of the device rooms and the devices thereof, etc. Then, it proceeds to step S22.

In step S22, a client device data file 122 is established, and the system administrator needs to enter device serial numbers, device names and descriptions thereof into the client device data file 122, so as to allow the user to realize information related to the devices. Then, it proceeds to step S23.

In step S23, an operating system data file 123 is established, and the system administrator needs to enter operating system serial numbers and operating system names into the operating system data file 123, so as to allow the user to realize information related to the operating systems installed in the devices.

FIG. 5 is a flowchart showing steps of making a reservation of a client device by the client device reservation method according to the present invention. As shown in FIG. 5, firstly in step S31, the user is allowed to login the client device reservation system via a terminal device 13a. A security control module 141 would firstly read the user data file 151 from the user database 15 to confirm the identity of the user, and automatically read the user group data file 153 to confirm the user's rights of database access and execution of system functions and display a personal web picture according to the user's rights. Then, it proceeds to step S32.

In step S32, a device room for making an inquiry or reservation is selected. An information inquiry module 142 displays graphs of device room locations, location information and device arrangement, and uses different identification codes to represent devices installed with different installed software/hardware, so as to allow the user to make an inquiry and reservation on a device located in the device room. Then, it proceeds to step S33.

In step S33, a graph of device to be inquired/reserved is selected from on the device room picture. The information inquiry module 142 displays information software/hardware installed in the device and a usage status thereof. If the device has been reserved, the information inquiry module 142 would also display information related to reservation such as the person who makes the reservation, starting time and deadline of reservation, project name, testing items, etc. Then, it proceeds to step S34.

In step S34, if the device has been reserved, the reservation process cannot be performed on this device, and it returns to step S33 to re-select a client device. If the device has not been reserved, the reservation process can be performed on this device. Then, it proceeds to step S35.

In step S35, a graph of device to be reserved is selected, and starting time of reservation, deadline of reservation, project name, operating system and testing items are entered, so as to perform the reservation process on the device. Moreover, after completion of the reservation process, a device reservation/cancellation module 143 would lock the reserved device to prevent other users from reserving the same device. Then, it proceeds to step S36.

In step S36, a data transmission module 147 is executed to read an identification number of the user from the user data file 151 of the user database 15, and find out email addresses of associated personnel from a staff basic database (not shown), such that a messaging indicating that the device has been reserved can be transmitted via a network unit 16 to email systems of the associated personnel.

FIG. 6 is a flowchart showing steps of performing overdue notification by the client device reservation method according to the present invention. As shown in FIG. 6, firstly in step S411, an overdue monitor module 148 is executed to read a deadline of the reservation from the client device usage status file 124 in the client device database 12, and compare the deadline with the system present time. Then, it proceeds to step S412.

In step S412, if the deadline is later than the system present time, it returns to step S411 to continue the comparison between the deadline and the system present time. If the deadline is earlier than the system present time, then it proceeds to step S413.

In step S413, the data transmission module 147 is executed to read the user's identification number from the user data file 151 of the user database 15, and find out the email addresses of the associated personnel via the staff basic database (not shown), such that overdue notification can be transmitted via the network unit 16 to the email systems of the associated personnel so as to inform the user that the reservation made thereby has expired and ask the user to login the system to cancel the reservation of the device and restore the physical device in the device room back to its original condition. Then, it returns to step S411 to continue the comparison between the deadline and the present system time.

FIG. 7 is a flowchart showing steps of performing feedback notification by the client device reservation method according to the present invention. As shown in FIG. 7, firstly in step S421, a device room where the device to be subject to feedback notification is located is selected, and graphs of location of the device room, location information, and device arrangement are displayed, so as to allow the user to perform feedback notification on the reserved device in the device room. Then, it proceeds to step S422.

In step S422, if the user only wishes to make a suggestion on a particular device, then he/she can select on a graph of the device. If the user wishes to make a suggestion on the system, then he/she can select an item for contacting the system administrator, such that the system would display a form picture for the user to enter a feedback message such as the suggestion for the system or problems/conditions incurred during using the device (for example, although the system indicates the usage status of the device as available for reservation, actually the device is still occupied by another user, or software/hardware of the device fails making the device not function properly) to be reported to the system administrator. Then, it proceeds to step S423.

In step S423, the data transmission module 147 is executed to read the user's identification number from the user data file 151 of the user database 15, and find out an email address of the system administrator via the staff basic database (not shown), such that the feedback message entered by the user can be transmitted via the network unit 16 to an email system of the system administrator, to serve as reference for the system administrator for device maintenance. Then, it proceeds to step S424.

In step S424, the data transmission module 147 is executed to read the user's identification number from the user data file 151 of the user database 15, and find out an email address of the user who enters the feedback message via the staff basic database (not shown), such that a processing condition of the system administrator can be transmitted via the network unit 16 to an email system of the user.

FIG. 8 is a flowchart showing steps of canceling the reservation of the client device by the client device reservation method according to the present invention. As shown in FIG. 8, firstly in step S431, a device room where the device having a reservation to be canceled is located is selected, and graphs of location of the device room, the location information and device arrangement are displayed, so as to allow the user to perform a process of canceling the reservation made for the device. Then, it proceeds to step S432.

In step S432, a graph of the reserved device whose reservation is to be canceled by the user is selected, and an item for canceling reservation is selected to perform the process of canceling the reservation of the device. Moreover, the device is unlocked for other users to make a reservation. Then, it proceeds to step S433.

In step S433, the data transmission module 147 is executed to read the user's identification number from the user data file 151 of the user database 15, and find out the email addresses of the associated personnel via the staff basic database (not shown), such that a message indicating that the reservation of the device has been canceled can be transmitted via the network unit 16 to the email systems of the associated personnel.

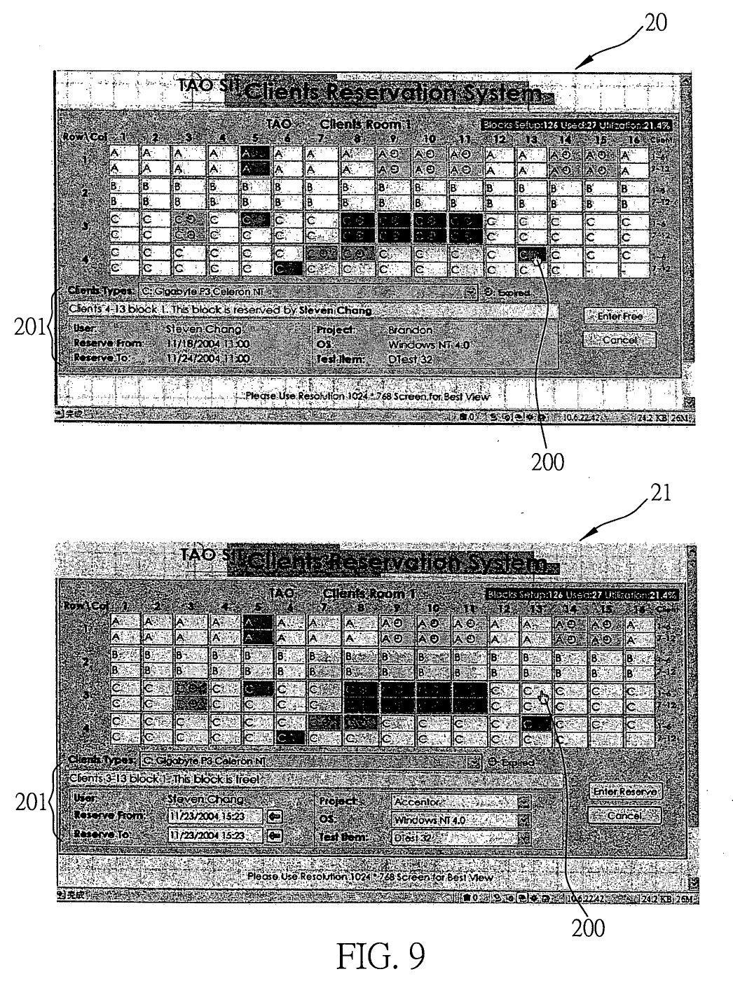

FIG. 9 is a diagram showing display pictures of device arrangement of device rooms and usage statuses provided by the client device reservation system according to the present invention. As shown in FIG. 9, the display pictures 20, 21 illustrate graphs of device arrangement of device rooms and usage statuses after executing the information inquiry module 142 shown in FIG. 1, wherein the number of device room rows, the number of device room columns, the number of devices in each row/column in device rooms are displayed, and information of software/hardware installed in the devices is also displayed, as well as different identification codes are used to represent different software/hardware installed in the devices. Moreover, if a device has been reserved, the pictures also display a reservation status of the device such as the user who made the reservation, starting time and deadline of reservation, project name, and testing items and so on. Reservations made by different users are represented in different colors. Further, a clock graph is added to the device graph, for indicating that the reservation of the device is overdue. As a result, the user can realize the device arrangement of the device room, the software/hardware information and the usage status, which facilitate the proceeding of device reservation, feedback notification and cancellation of reservation. For instance, when the cursor 200 on the display pictures 20, 21 stops at a particular device position, a status information field 201 of the display pictures 20, 21 would display current information corresponding to the pointed device.

FIG. 10 is a diagram showing display pictures of statistical analysis reports on a device usage rate provided by the client device reservation system according to the present invention. As shown in FIG. 10, the display pictures illustrate various report formats preset by the report generation module 146 shown in FIG. 1, which comprises a statistical analysis report 22 based on a usage rate of each device in the device rooms generated by the result generated from module 145, a statistical analysis report 23 based on an everyday usage rate of each device room, and a usage inquiry report based on a usage status of each device generated by the information inquiry module 142, so as to list out the usage rate of each device room and the usage rate and the usage status of each device, to serve as reference for the system administrator for construction, expansion and reduction of the devices in the device rooms.

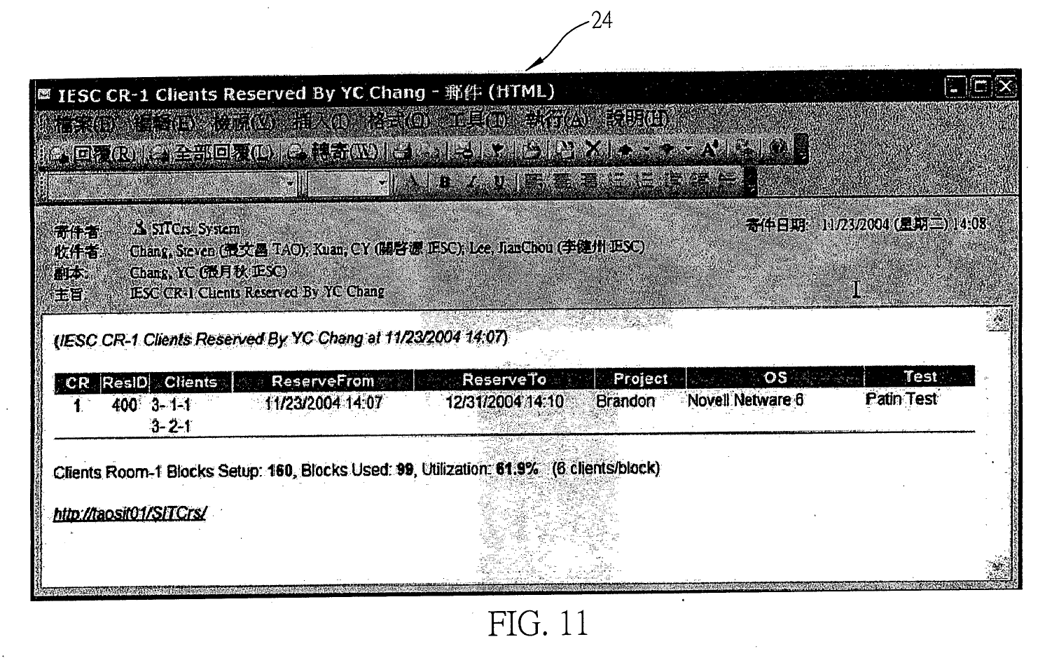

FIG. 11 is a diagram showing a display picture of reservation/cancellation notification provided by the client device reservation system according to the present invention. As shown FIG. 11, the display picture 24 is an email picture showing a message that indicates success of a reservation or cancellation of a reservation and is transmitted from the data transmission module 147 via the network unit 16 to the email systems of the associated personnel after executing the reservation/cancellation module 142 shown in FIG. 1, so as to inform the associated personnel that a reservation of the device has been completed or canceled. The display picture 24 also displays the name and location of a device room where the device is located, starting time and deadline of reservation, project name, testing items and a usage rate of the device in the device room, so as to allow the user and the system administrator to realize the condition of reservation/reservation-cancellation of the device.

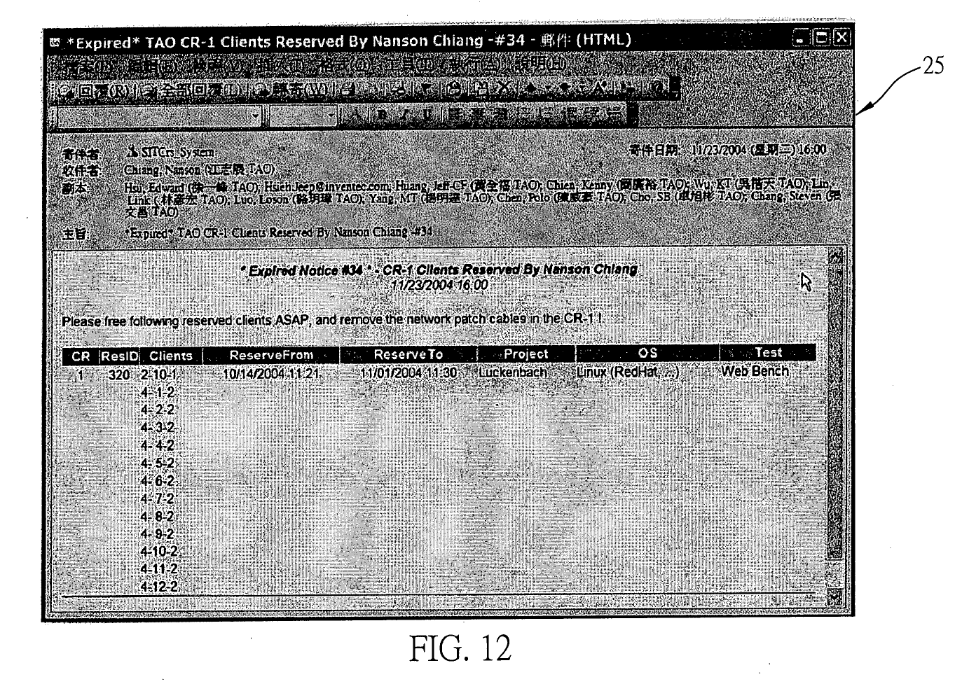

FIG. 12 is a diagram showing a display picture of overdue notification provided by the client device reservation system according to the present invention. As shown in FIG. 12, the display picture 25 is an email picture showing a message that indicates an overdue reservation and is transmitted from the data transmission module 147 via the network unit 16 to the email systems of the associated personnel after executing after executing the overdue monitor module 148, so as to inform the associated personnel that the reservation of the device is now overdue. The display picture 25 also displays the name and location of a device room where the device is located, starting time and deadline of reservation, project name, testing items, etc., so as to allow the user and the system administrator to realize that the reservation of the device is overdue and ask them to perform a further processing step.

Therefore, the client device reservation system and method in the present invention allows a user to remotely inquire a usage status of a client device, and make a reservation on the client device under a condition that the client device is available for reservation. Moreover, the present invention also allows the user to make suggestions and report problems/conditions incurred during using the device back to a system administrator, to serve as reference for system maintenance. As a result, a problem that a usage status of the client device displayed by the system is not consistent with an actual usage status of the physical client device can be avoided.

The invention has been described using exemplary preferred embodiments. However, it is to be understood that the scope of the present invention is not limited to the disclosed embodiments. On the contrary, it is intended to cover various modifications and similar arrangements. For example, the foregoing terminal device is not limited to a computer product, but also includes mobile phone, personal digital assistant, etc. according to the practical requirements. The scope of the claims, therefore, should be accorded the broadest interpretation so as to encompass all such modifications and similar arrangements.

What is claimed is:

1. A client device reservation system comprising:
a network unit for performing data transmission;
a client device database for at least storing client device data;
a user database for storing user data;
a web server for installing a client device reservation interface; and
at least one terminal device connected to the web server by the network unit, for allowing a user to login the web server via the terminal device to operate the client device reservation interface, and allowing the client device reservation interface to determine an access right of the user and a client device status according to the data stored in the client device database and the user data stored in the user database, such that the user remotely performs a reservation of a client device or message feedback, and the client device database is updated according to the user's performance.

2. The client device reservation system of claim 1, wherein the client device reservation interface comprises:
a security control module for deciding the user's rights of accessing the client device database and performing functions provided by the system according to the user database, and for displaying a personal web according to the user's rights;
a device reservation/cancellation module for cooperating with the security control module to allow the user to reserve a client device that has not been reserved, and for locking the reserved client device to prevent other users from reserving the same client device, the device reservation/cancellation module further for allowing the user to cancel the reservation of the client device and unlocking the locked client device for the other users to reserve;
a data transmission module for sending relevant notification to email systems of associated personnel via the network unit;
a user feedback module for allowing the user to provide a feedback message on the reserved client device, storing the feedback message in a user feedback data file of the client device database, and sending the feedback message to the associated personnel via the data transmission module; and
an overdue monitor module for regularly comparing present time of the system with a reservation deadline, and sending overdue notification via the data transmission module when the present time is later than the reservation deadline.

3. The client device reservation system of claim 1, wherein the network unit is Internet.

4. The client device reservation system of claim 1, wherein the network unit is an intranet.

5. The client device reservation system of claim 1, wherein the client device database is installed in the web server.

6. The client device reservation system of claim 1, wherein the web server is connected to the client device database by the network unit.

7. The client device reservation system of claim 1, wherein the user database is installed in the web server.

8. The client device reservation system of claim 1, wherein the web server is connected to the user database by the network unit.

9. The client device reservation system of claim 1, wherein the message feedback refers to reporting of the user's comment on the client device after using the client device.

10. A client device reservation method comprising the steps of:
providing a network unit connected to a web server and a terminal device;
installing a client device reservation interface in the web server connected with the network unit and installing a browser in the terminal device;
storing user data in a user database;
storing client device data in a client device database; and
allowing a user to be linked to the web server by the browser of the terminal device to operate the client device reservation interface, and allowing the client device reservation interface to determine an access right of the user and a client device status according to the data stored in the client device database and the user data stored in the user database, such that the user remotely performs a reservation of a client device or message feedback, and the client device database is updated according to the user's performance.

11. The client device reservation method of claim 10, wherein the process of performing the reservation and message feedback comprises:
allowing the client device reservation interface to reserve a client device that has not been reserved, lock the reserved client device to prevent other users from reserving the same client device, and notify associated personnel via emails; and
allowing the client device reservation interface to build a user feedback data file according to a feedback message of the use and notify the associated personnel by emails.

12. The client device reservation method of claim 11, wherein the client device reservation interface further allows the user to cancel the reservation of the client device and unlocks the locked client device for the other users to reserve, as well as notifies the associated personnel by emails.

13. The client device reservation method of claim 10, wherein the client device reservation interface is further capable of monitoring whether the reservation of the client device is overdue, and sending an overdue message to the associated personnel by emails.

14. The client device reservation method of claim 10, wherein the network unit is Internet.

15. The client device reservation method of claim 10, wherein the network unit is an intranet.

16. The client device reservation method of claim 10, wherein the client device database is installed in the web server.

17. The client device reservation method of claim 10, wherein the web server is connected to the client device database by the network unit.

18. The client device reservation method of claim 10, wherein the user database is installed in the web server.

19. The client device reservation method of claim 10, wherein the web server is connected to the user database by the network unit.

20. The client device reservation method of claim 10, wherein the message feedback refers to reporting of the user's comment on the client device after using the client device.
